(19) United States
(12) Patent Application Publication
(10) Pub. No.: US 2025/0068774 A1
(43) Pub. Date: Feb. 27, 2025

(54) MICRO-CONTROLLER, SECURE SYSTEM AND PROTECTION METHOD

(71) Applicant: Nuvoton Technology Corporation, Hsinchu Science Park (TW)

(72) Inventor: Zong-Min LIN, Kaohsiung City (TW)

(21) Appl. No.: 18/782,333

(22) Filed: Jul. 24, 2024

(30) Foreign Application Priority Data
Aug. 22, 2023 (TW) 112131441

(51) Int. Cl. G06F 21/55; H04L 9/08

(52) U.S. Cl. CPC G06F 21/74; H04L 9/088

(57) ABSTRACT

A micro-controller including a non-secure world, a secure world, and a processing circuit is provided. The non-secure world stores a neural network model including an encrypted operator and an un-encrypted operator. The secure world stores a key and includes a decryption circuit. In a non-secure mode, the processing circuit interprets the un-encrypted operator. In a secure mode, the processing circuit directs the decryption circuit to use the key to decrypt the encrypted operator to generate a decrypted result. In the secure mode, the processing circuit interprets the decrypted result to generate second output data and stores the second output data in the non-secure world.

### CROSS REFERENCE TO RELATED APPLICATIONS

This Application claims priority of Taiwan Patent Application No. 112131441, filed on Aug. 22, 2023, the entirety of which is incorporated by reference herein.

### BACKGROUND OF THE INVENTION

### Field of the Invention

The present invention relates to a micro-controller, and, in particular, to a micro-controller that processes neural network models.

### Description of the Related Art

As technological development has advanced, information security issues have increased. Before storing it in a memory, data may be intercepted by illegal users. Even if the data is stored in the memory, the data may be stolen by illegal users.

### BRIEF SUMMARY OF THE INVENTION

In accordance with an embodiment of the disclosure, a micro-controller comprises a non-secure world, a secure world, and a processing circuit. The non-secure world comprises a first storage circuit. The first storage circuit stores a neural network model which comprises an encrypted operator and a first un-encrypted operator. The secure world comprises a key-store device, a decryption circuit, and a second storage circuit. The key-store device stores a key. The decryption circuit uses the key to decrypt the encrypted operator to generate a decrypted result. The second storage circuit stores the decryption result. The processing circuit interprets the first un-encrypted operator and the decrypted result. In a non-secure mode, the processing circuit interprets the first un-encrypted operator to generate first output data. In a secure mode, the processing circuit directs the decryption circuit to use the key to decrypt the encrypted operator. In the secure mode, the processing circuit interprets the decrypted result to generate second output data and stores the second output data in the first storage circuit.

In accordance with another embodiment of the disclosure, a secure system comprises an offline tool and a micro-controller. The offline tool comprises an encryption circuit. The encryption circuit receives a neural network model comprising a first operator and a second operator. The encryption circuit uses a first key to encrypt the second operator to generate a first encrypted operator. The micro-controller comprises a non-secure world, a secure world, and a processing circuit. The non-secure world comprises a first storage circuit. The first storage circuit stores the first operator and the first encrypted operator. The secure world comprises a key-store device, a decryption circuit, and a second storage circuit. The key-store device stores the first key. The decryption circuit uses the first key to decrypt the first encrypted operator to generate a decrypted result. The second storage circuit stores the decryption result. The processing circuit interprets the first operator and the decrypted result. In a non-secure mode, the processing circuit interprets the first operator to generate first output data. In a secure mode, the processing circuit interprets the decrypted result to generate second output data and stores the second output data in the first storage circuit.

A protection method for a micro-controller is provided. The micro-controller comprises a non-secure world and a secure world. An exemplary embodiment of the protection method is described in the following paragraph. A first operator and a first encrypted operator are stored in the non-secure world. A key is stored in the secure world. In a non-secure mode, the first operator is interpreted to generate first output data. In a secure mode, the key is used to decrypt the first encrypted operator to generate a first decrypted result, the first decrypted result is interpreted to generate second output data, and the second output data is stored in the non-secure world.

The protection method may be practiced by the systems which have hardware or firmware capable of performing particular functions and may take the form of program code embodied in a tangible media. When the program code is loaded into and executed by an electronic device, a processor, a computer or a machine, the electronic device, the processor, the computer or the machine becomes a micro-controller and a secure system for practicing the disclosed method.

### BRIEF DESCRIPTION OF THE DRAWINGS

The present invention can be more fully understood by reading the subsequent detailed description and examples with references made to the accompanying drawings, wherein:

FIG. 1 is a schematic diagram of an exemplary embodiment of a secure system according to various aspects of the present disclosure.

FIG. 2 is a schematic diagram of an exemplary embodiment of a controller according to various aspects of the present disclosure

FIG. 3 is a schematic diagram of an exemplary embodiment of a processing circuit operating in a non-secure mode according to various aspects of the present disclosure

FIG. 4 is a schematic diagram of an exemplary embodiment of the processing circuit operating in a secure mode according to various aspects of the present disclosure

FIG. 5 is a flowchart of a protection method in accordance with an embodiment of the present disclosure.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

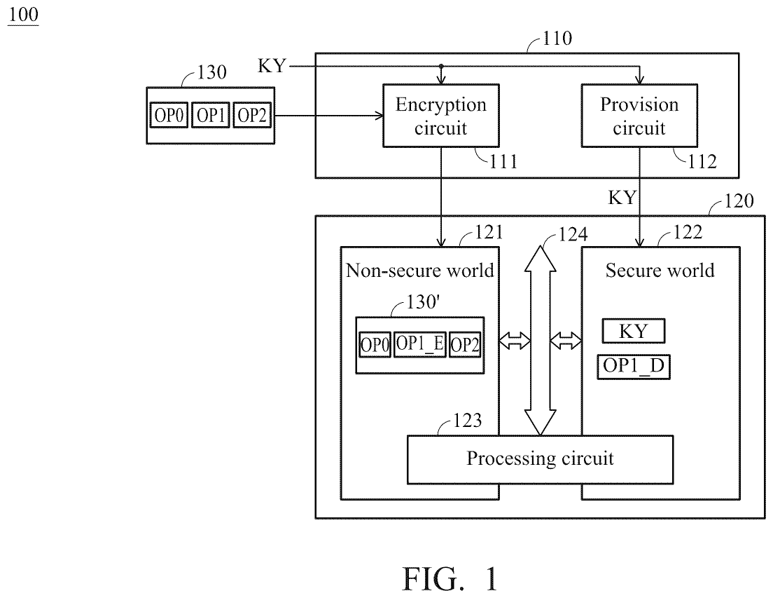

FIG. 1 is a schematic diagram of an exemplary embodiment of a secure system according to various aspects of the present disclosure. As shown in FIG. 1, the secure system 100 comprises an offline tool 110 and a micro-controller 120. The offline tool 110 receives a key KY and a neural network model 130. The number of keys is not limited in the present disclosure. In other embodiments, the offline tool 110 receives more keys. In some embodiments, the offline tool 110 comprises a storage circuit (not shown) to store the key KY and the neural network model 130.

The neural network model 130 comprises operators OP0˜OP2. The number of operators is not limited in the present disclosure. The neural network model 130 may comprise more or fewer operators. In this embodiment, each of the operators OP0˜OP2 comprises pre-established network architectures and a large number of parameters such as weights and bias values.

Additionally, each of the operators OP0˜OP2 comprises tag information to indicate the kind of network architecture. Taking the operator OP0 as an example, when the tag information of the operator OP0 matches a first predetermined value, this indicates that the operator OP0 belongs to a first network architecture, such as a convolution neural network (CNN) architecture. When the tag information of the operator OP0 matches a second predetermined value, this indicates that the operator OP0 belongs to a second network architecture, such as a fully-connected (FC) architecture. When the tag information of the operator OP0 matches a third predetermined value, this indicates that the operator OP0 belongs to a third network architecture, such as a pooling architecture.

In one embodiment, the neural network model 130 is served as a deep learning model. The deep learning model comprises multiple layers of neural networks. For example, the neural network model 130 may comprise at least one of a CNN layer, a FC layer and a pooling layer. Each layer of the neural networks is transformed into an operator, such as one of the operators OP0˜OP2. Additionally, each operator comprises weights, bias values, etc. In some embodiment, each of the operators OP0˜OP2 further comprises content information. The content information may contain a large number of parameters (e.g., weights and bias values) and corresponding neural network information.

In this embodiment, the offline tool 110 comprises an encryption circuit 111 and a provision circuit 112. The encryption circuit 111 uses the key KY to encrypt at least one of the operators OP0˜OP2 to generate an encrypted operator. In this case, the encrypted operator has tag information and encrypted information. In one embodiment, the encryption operation performed by the encryption circuit 111 is a symmetric encryption operation, such as AES algorithms.

The offline tool 110 outputs un-encrypted operator and the encrypted operation to the micro-controller 120. For example, assuming that the encryption circuit 111 uses the key KY to encrypt the operator OP1 to generate an encrypted operator OP1_E. In this case, the encryption circuit 111 encrypts the tag information and the content information of the operator OP1 to generate encrypted information. The encryption circuit 111 uses the encrypted information and the tag information as the encrypted operator OP1_E. In one embodiment, the encryption circuit 111 sets the tag information of the encrypted operator OP1_E as a predetermined value. The off line tool 110 outputs the un-encrypted operators OP0 and OP2 and the encrypted operator OP1_E to the micro-controller 120. The un-encrypted operators OP0 and OP2 and the encrypted operator OP1_E constitute a neural network model 130′.

In one embodiment, the encryption circuit 111 encrypts the operators OP1 and OP2 and provides the encrypted result as the encrypted operator OP1_E. For example, the encryption circuit 111 encrypts the tag information and the content information of the operators OP0 and OP2 to generate encrypted information. The encryption circuit 111 serves the encrypted information and tag information as the encrypted operator OP1_E. In this case, the encryption circuit 111 sets the tag information of the encrypted operator OP1_E to a predetermined value. Then, the encryption circuit 111 outputs the un-encrypted operator OP0 and the encrypted operator OP1_E to the micro-controller 120.

In other embodiments, the encryption circuit 111 uses different keys to encrypt different operators. For example, the encryption circuit 111 uses a first key to encrypt the operator OP1 to generate a first encrypted operator, and uses a second key to encrypt the operator OP2 to generate a second encrypted operator. In this case, the encryption circuit 111 outputs the un-encrypted operator OP0, the first encrypted operator and the second encrypted operator to the micro-controller 120.

In another embodiment, the encryption circuit 111 uses a single key to encrypt different operators. For example, the encryption circuit 111 uses the key KY to encrypt the operator OP0 to generate a first encrypted operator, and uses the key KY to encrypt the operator OP2 to generate a second encrypted operator. In this case, the encryption circuit 111 outputs the first encrypted operator, the un-encrypted operator OP1, and the second encrypted operator to the micro-controller 120.

The provision circuit 112 utilizes a secure key provision procedure to provision the key KY to the micro-controller 120. In other embodiments, when the encryption circuit 111 uses different keys to encrypt different operators, the provision circuit 112 provisions different keys to the micro-controller 120. Therefore, the micro-controller 120 is capable of performing a decryption operation for different encrypted operators according to the different keys. In one embodiment, the provision circuit 112 is a separate circuit from the offline tool 100.

In other embodiments, the encryption circuit 111 may encrypt the key KY and then provide the encrypted result to the provision circuit 112. The provision circuit 112 provisions the encrypted result to the micro-controller 120. The present disclosure does not limit how the encryption circuit 111 encrypts the key KY. In one embodiment, the encryption circuit 111 utilizes an asymmetric encryption algorithm, such as an ECC algorithm or an RSA algorithm to encrypt the key KY.

In this embodiment, the micro-controller 120 comprises a non-secure world 121, a secure world 122 and a processing circuit 123. The non-secure world 121 stores the neural network model 130′. The neural network model 130′ comprises operators OP0 and OP2, and the encrypted operator OP1_E. In this case, since the operators OP0 and OP2 are not encrypted, the operators OP0 and OP2 are referred to as un-encrypted operators.

The secure world 122 stores the key KY. The key KY is not encrypted. In other embodiment, the secure world 122 stores an encrypted key. In this embodiment, the key KY is provided by the provision circuit 112, but the disclosure is not limited in the present disclosure. In other embodiments, the key KY may be provisioned into the secure world 122 via a network interface.

The processing circuit 123 accesses the non-secure world 121 and the secure world 122 via a bus 124. In one embodiment, the processing circuit 123 supplies the non-secure mode and the secure mode of TrustZone structure. In the non-secure mode, the processing circuit 123 interprets the operators OP0 and OP2 of the non-secure world 121. In the secure mode, the processing circuit 123 uses the key KY to decrypt the encrypted operator OP1_E to generate a decrypted result OP1_D. Then, the processing circuit 123 interprets the decrypted result OP1_D. In this case, the decrypted result OP1_D is the same as the operator OP1.

Since the neural network model 130′ comprises at least one encrypted operator, even if an illegal person steals the neural network model 130′ in the non-secure world 121, the illegal person cannot use the neural network model 130′. Additionally, since some important operator (e.g., OP1) of the neural network model 130 are encrypted by the encryption circuit 111 and others are not, a balance between security and computational load is achieved. Furthermore, the secure world 122 provides a trusted operation environment. A standard encryption-decryption operation is performed in the decrypted result OP1_D so that the confidentiality of the neural network model can be ensured and the neural network model does not be stolen by malicious users outside the secure world.

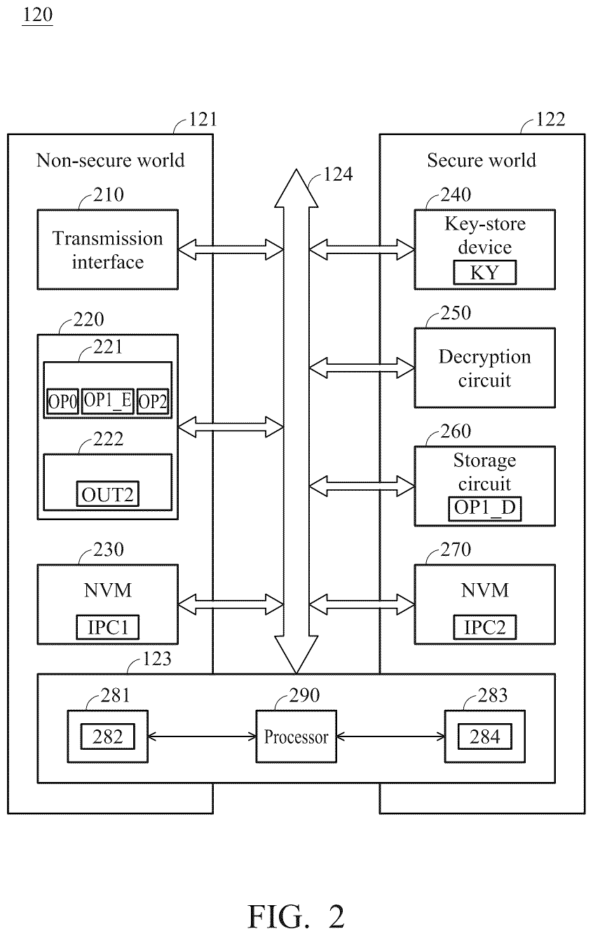

FIG. 2 is a schematic diagram of an exemplary embodiment of a controller according to various aspects of the present disclosure. The non-secure world 121 comprises a storage circuit 220. The storage circuit 220 comprises a memory 221. The memory 221 stores the operators OP0 and OP2, and the encrypted operator OP1_E. The kind of memory 221 is not limited in the present disclosure. In one embodiment, the memory 221 is a volatile memory, such as a random access memory (RAM).

In other embodiments, the non-secure world 121 further comprises a transmission interface 210. The transmission interface 210 receives the operators OP0 and OP2, and the encrypted operator OP1_E from the offline tool 110. The transmission interface 210 may directly transmit the operators OP0 and OP2, and the encrypted operator OP1_E to the storage circuit 220. The kind of transmission interface 210 is not limited in the present disclosure. In one embodiment, the transmission interface 210 is Internet interface.

In other embodiments, the non-secure world 121 further comprises a non-volatile memory (NVM) 230. The NVM 230 stores an interpretation program code IPC1. In the non-secure mode, the processing circuit 123 executes the interpretation program code IPC1 to interpret the un-encrypted operators OP0 and OP2. In one embodiment, the interpretation program code IPC1 is configured to interpret a model that matches a TensorFlow lite standard. In some embodiments, the interpretation program code IPC1 is a software kernel.

The secure world 122 comprises a key-store device 240, a decryption circuit 250 and a storage circuit 260. The key-store device 240 stores the key KY. The number of keys stored in the key-store device 240 is not limited in the present disclosure. In some embodiments, when the encryption circuit 111 uses many keys to perform an encryption operation, the key-store device 240 stores the keys used by the encryption circuit 111.

In other embodiments, the secure world 122 comprises a transmission interface (not shown). The transmission interface of the secure world 122 receives the key KY from the provision circuit 112 and stores the key KY in the key-store device 240. In another embodiment, the key-store device 240 receives the key KY from the provision circuit 112 via the bus 124.

The decryption circuit 250 uses the key KY to perform a decryption operation for the encrypted information of the encrypted operator OP1_E to generate the decrypted result OP1_D. The decrypted result OP1_D comprises at least one operator. After processing, the tag information and the content information of the decrypted result OP1_D are the same as the tag information and the content information of the operator OP1. In another embodiment, assuming that the encryption circuit 111 uses the same key to encrypt the operators OP1 and OP2. In this case, after the decryption circuit 250 processes the encrypted operators OP1 and OP2, the decrypted result OP1_D comprises a first decrypted operator and a second decrypted operator. The tag information and the content information of the first decrypted operator are the same as the tag information and the content information of the operator OP1. The tag information and the content information of the second decrypted operation are the same as the tag information and the content information of the operator OP2. In other embodiments, when the key KY is an encrypted key, the decryption circuit 250 first decrypts the encrypted key and uses the decrypted key to process the encrypted information of the encrypted operator (e.g., OP1_E).

The storage circuit 260 stores the decrypted result OP1_D. The kind of storage circuit 260 is not limited in the present disclosure. In one embodiment, the storage circuit 260 comprises a volatile memory. In some embodiments, the decryption circuit 250 is directly connected to the storage circuit 260 to directly write the decrypted result OP1_D into the storage circuit 260.

In other embodiments, the secure world 122 further comprises a non-volatile memory 270. The non-volatile memory 270 stores an interpretation program code IPC2. In one embodiment, the interpretation program code IPC2 is configured to interpret a model that matches the TensorFlow lite standard. In some embodiments, the interpretation program code IPC2 is a software kernel.

In a secure mode, the processing circuit 123 utilizes the interpretation program code IPC2 to interpret the decrypted result OP1_D to generate output data OUT2. The processing circuit 123 stores the output data OUT2 in the storage circuit 20 of the non-secure world 121. In one embodiment, the storage circuit 220 comprises a memory 222. The memory 222 stores the output data OUT2. In this case, the memory 221 is independent of the memory 220. In other embodiments, the storage circuit 220 comprises a single memory to store the operators OP0 and OP2, the encrypted operator OP1_E, and the output data OUT2.

In some embodiments, the processing circuit 123 comprises memories 281 and 283, and a processor 290. The memory 281 stores a software program 282. The kind of memory 281 is not limited in the present disclosure. The memory 281 may be a non-volatile memory or a volatile memory. In other embodiments, the software program 282 may store in the storage circuit 220 or the non-volatile memory 230.

The memory 283 stores a software program 284. The kind of memory 283 is not limited in the present disclosure. The memory 283 may be a non-volatile memory or a volatile memory. In other embodiments, the software program 284 may be stored in the storage circuit 260 or the non-volatile memory 270.

The processor 290 accesses the memories 281 and 283. In the non-secure mode, the processor 290 executes the software program 282 to interpret the operators OP0 and OP2 (referred to as un-encrypted operators). In the secure mode, the processor 290 executes the software program 284 to interpret the decrypted result OP1_D. In one embodiment, the processor 290 is an universal processor.

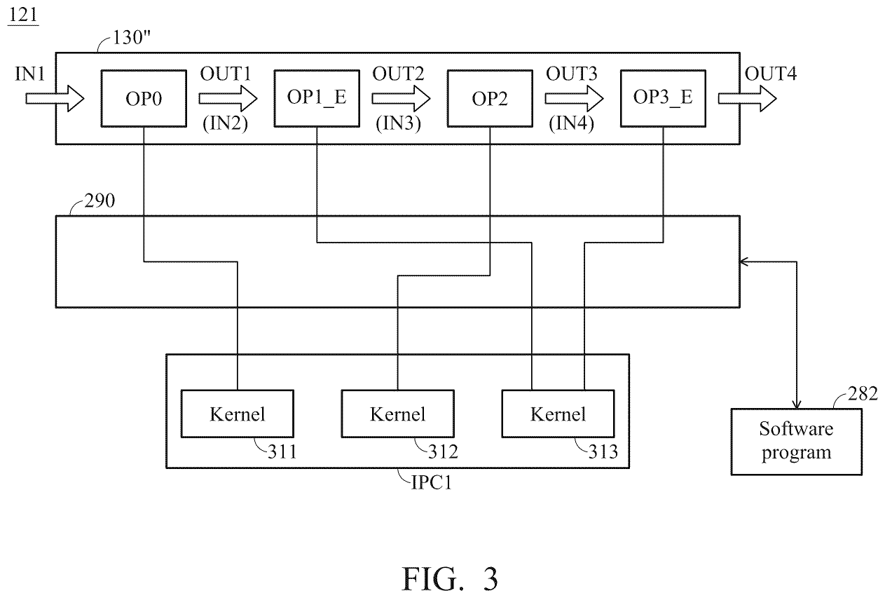

FIG. 3 is a schematic diagram of an exemplary embodiment of the processing circuit operating in the non-secure mode according to various aspects of the present disclosure. In one embodiment, the micro-controller 120 receives an external requirement and interprets the neural network model 130″ according to the external requirement. After finishing the interpretation operation, the micro-controller 120 provides output data OUT4 referred to as output inferenced data. In one embodiment, the micro-controller 120 utilizes the neural network model 130″ to execute an image identification inference or a voice identification inference.

In this embodiment, the neural network model 130″ is provided by an offline tool and comprises operators OP0, OP1_2, OP2, and OP2. The operators OP0 and OP2 are not encrypted so that the operators OP0 and OP2 are referred to as un-encrypted operators. The operators OP1_E and OP3_E are encrypted so that the operators OP1_E and OP3_E are referred to as encrypted operators. In one embodiment, the offline tool uses a single key or different keys to encrypt two operators to generate the operators OP1_E and OP3_E.

After receiving the external requirement, the processor 290 enters a non-secure mode. In the non-secure mode, the processor 290 executes the software program 282 to interpret the operator OP0. The processor 290 reads the tag information of the operator OP0 and calls the kernel 311 according to the tag information of the operator OP0. The processor 290 processes the content information of the operator OP0 and the input data IN1 according to the kernel 311 to generate output data OUT1. In one embodiment, the kernel 311 is an algorithm. The processor 290 substitutes the operator OP0 and the input data IN1 with the kernel 311 and provides the substituted result as the output data OUT1.

The processor 290 uses the output data OUT1 as the input data IN2 and provides the input data IN2 to the encrypted operator OP1_E. The processor 290 reads the tag information of the encrypted operator OP1_E and calls a kernel 313 according to the tag information of the encrypted operator OP1_E. In one embodiment, the kernel 313 comprises a non-secure callable secure function which is referred to as a trusted machine learning execution application programming interface. In this case, the processor 290 calls the kernel located in the secure world according to the characteristic of the non-secure callable secure function. Then, the processor 290 leaves the non-secure mode and enters a secure mode.

In the secure mode, the processor 290 orders that the decryption circuit 250 uses the key KY to decrypt the encrypted information of the encrypted operator OP1_E to generate the decrypted result OP1_D. The processor 290 interprets the decrypted result OP1_D to generate the output data OUT2. The processor 290 stores the output data OUT2 in the non-secure world 121 and enters the non-secure mode.

In the non-secure mode, the processor 290 executes the software program 282 to interpret the operator OP2. In the interpretation process, the processor 290 reads the tag information of the operator OP2 and provides the output data OUT2 used as the input data IN3 to the operator OP2. The processor 290 calls a kernel 312 according to the tag information of the operator OP2. The processor 290 calculates the content information of the operator OP2 and the input data IN3 to generate output data OUT3.

The processor 290 uses the output data OUT3 as the input data IN4 and provides the input data IN4 to the encrypted operator OP3_E. The processor 290 reads the tag information of the encrypted operator OP3_E and calls a kernel 313 according to the tag information of the encrypted operator OP3_E. At this time, the processor 290 leaves the non-secure mode and enters the secure mode.

In the secure mode, the processor 290 orders that the decryption circuit 250 decrypts the encrypted information of the encrypted operator OP3_E to generate a decrypted result OP3_D. The processor 290 stores the output data OUT4 in the non-secure world 121 and enters the non-secure mode. In this case, the final output data (i.e., OUT4) is output inference data.

The contents of the software programs 282 and 284 are not limited in the present disclosure. In one embodiment, each of the software programs 282 and 284 is an interpreter of TensorFlow lite to provide a software execution environment for TensorFlow lite. In this case, the processor 290 utilizes the software programs 282 and 284 to interpret each operator in the file of TensorFlow lite. The processor 290 calls a corresponding kernel according to the tag information of an operator to perform a corresponding algorithm.

In some embodiments, the kernels 311˜313 constitute the interpretation program code IPC1. The number of kernels is not limited in the present disclosure. In other embodiments, the interpretation program code IPC1 has more kernels. The present disclosure does no limit what kind of operations the kernels 311 and 312 performs. Taking the kernel 311 as an example, the kernel 311 may perform a CNN operation, a FC operation or a pooling operation for a corresponding operator and corresponding input data. In other embodiments, different operators may correspond to the same kernel. For example, although the operators OP0 and OP2 in FIG. 3 correspond to different kernels, the operators OP0 and OP2 may correspond to the same kernel.

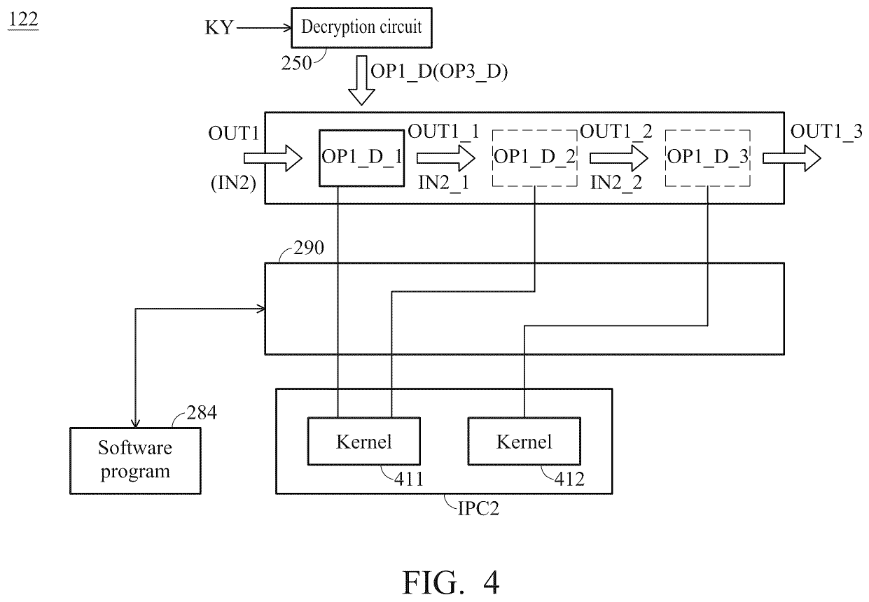

FIG. 4 is a schematic diagram of an exemplary embodiment of the processing circuit operating in the secure mode according to various aspects of the present disclosure. In the secure mode, the processor 290 orders that the decryption circuit 250 uses the key KY to decrypt the encrypted information of the encrypted operator OP1_E to generate the decrypted result OP1_D. The processor 290 executes the software program 284 to interpret the decrypted result OP1_D.

In one embodiment, the decrypted result OP1_D comprises a decrypted operator OP1_D_1. During the interpretation process, the processor 290 reads the tag information of the decrypted operator OP1_D_1 and uses the output data OUT1 as the input data IN2 of the decrypted operator OP1_D_1. The processor 290 calls a kernel 411 according to the tag information of the decrypted operator OP1_D_1. The processor 290 processes the content information of the decrypted operator OP1_D_1 and the input data IN2 to generate the output data OUT1_1. After finishing the interpretation operation, the processor 290 stores the output data OUT1_1 in the non-secure world 121. Then, the processor 290 leaves the secure mode and enters the non-secure mode. In the non-secure mode, the processor 290 provides the output data OUT1_1 as the input data IN3 of the operator OP2 shown in FIG. 3.

In another embodiment, the decrypted result OP1_D comprises decrypted operators OP1_D_1˜OP1_D_3. In this case, the processor 290 interprets the decrypted operator OP1_D_1 to generate the output data OUT1_1. Then, the processor 290 interprets the decrypted operator OP1_D_2. During the interpretation process, the processor 290 reads the tag information of the decrypted operator OP1_D_2 and uses the output data OUT1_1 as the input data IN2_1 of the decrypted operator OP1_D_2. The processor 290 calls the kernel 411 according to the tag information of the decrypted operator OP1_D_2. The processor 290 processes the content information of the decrypted operator OP1_D_2 and the input data IN2_1 according to the algorithm of the kernel 411 to generate the output data OUT1_2.

Then, the processor 290 interprets the decrypted operator OP1_D_3. During the interpretation process, the processor 290 reads the tag information of the decrypted operator OP1_D_3 and uses the output data OUT1_2 as the input data IN2_2 of the decrypted operator OP1_D_3. The processor 290 calls the kernel 412 according to the tag information of the decrypted operator OP1_D_3. The processor 290 processes the content information of the decrypted operator OP1_D_3 and the input data IN2_2 according to the algorithm of the kernel 412 to generate the output data OUT1_3. After finishing the interpretation operation, the processor 290 stores the output data OUT1_3 in the non-secure world 121 and enters the non-secure mode. In the non-secure mode, the processor 290 provides the output data OUT1_3 as the input data IN3 of the operator OP2 shown in FIG. 3 and executes the software program 282 to interpret the operator OP2. In one embodiment, the kernels 411 and 412 are provided as the interpretation program code IPC2.

Refer to FIG. 3, when the processor 290 interprets the encrypted operator OP3_E, the processor 290 calls the kernel 313 according to the tag information of the encrypted operator OP3_E. At this time, the processor 290 exits the non-secure mode and enters the secure mode. In the secure mode, the processor 290 directs the decryption circuit 250 to decrypt the encrypted information of the encrypted operator OP3_E to generate the decrypted result OP3_D. The processor 290 interprets the decrypted result OP3_D. Since the characteristic of the decrypted result OP3_D is the same as the characteristic of the decrypted result OP1_D, the related description is omitted here. Additionally, the method in which the processor 290 interprets the decrypted result OP3_D is the same as the method in which the processor 290 interprets the decrypted result OP1_D, the related description is omitted here.

Since the neural network model 130″ in the non-secure world 121 comprises the encrypted operators, even if an illegal user steals the neural network model 130″, the neural network model 130″ cannot be used. Furthermore, since the secure world 122 provides a trusted computing environment, the security of the encrypted operators OP1_E and OP3_E can be improved.

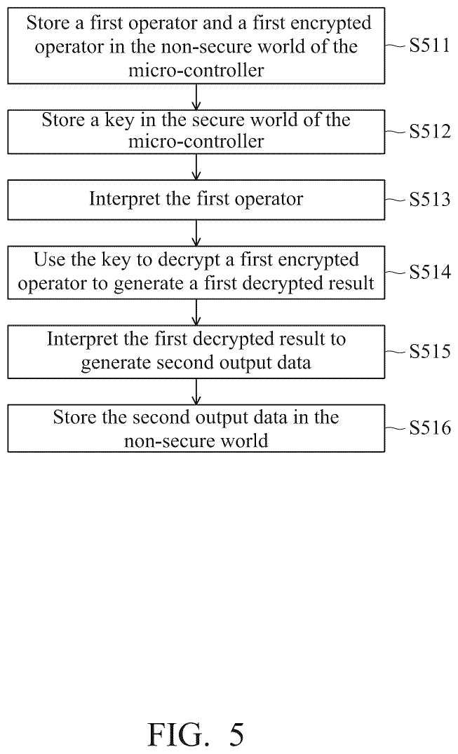

FIG. 5 is a flowchart of a protection method in accordance with an embodiment of the present disclosure. The protection method is applied in a micro-controller. The micro-controller comprises a non-secure world and a secure world. The protection method may take the form of a program code. When the program code is loaded into and executed by a machine, the machine thereby becomes a micro-controller and a secure system for practicing the protection method.

A first operator and a first encrypted operator are stored in the non-secure world of the micro-controller (step S511). A key is stored in the secure world of the micro-controller (step S512). In one embodiment, the first operator, the first encrypted operator and the key are provided by a offline tool. In this case, the offline tool uses the key to encrypt at least one important operator of the neural network model to generate the first encrypted operator. The execution order of step S511 and S512 is not limited in the present disclosure. Step S512 may lead step S511.

In this embodiment, the micro-controller interprets the un-encrypted operator in the non-secure world and decrypts the encrypted information of the encrypted operator in the secure world. After decrypting the encrypted operator, the micro-controller interprets the decrypted operator. For example, in a non-secure mode, the micro-controller interprets the first operator to generate first output data (step S513). In one embodiment, the micro-controller stores the first output data in the non-secure world. In a secure mode, the micro-controller executes steps S514˜S516. Step S514 is executed to use the key to decrypt the encrypted information of the encrypted operator to generate a first decrypted result. Step S515 is executed to interpret the first decrypted result to generate second output data. Step S516 is executed to store the second output data in the non-secure world.

The present disclosure does not limit the order in which the micro-controller processes the first operator and the first encrypted operator. When the first operator has higher priority than the first encrypted operator, the micro-controller processes the first operator and then processes the first encrypted operator. Therefore, steps S513˜S516 are executed in sequence. For example, the micro-controller first interprets the first operator in the non-secure world to obtain first output data. Then, the micro-controller decrypts the encrypted information of the first encrypted operator to generate a first decrypted result and then interprets the first decrypted result. During performing the interpretation operation, the micro-controller provides the first output data of the first operator as the input data of the first decrypted result.

However, when the first encrypted operator has higher priority than the first operator, the micro-controller processes the first encrypted operator and then processes the first operator. Therefore, steps S514˜S516 lead step S513. For example, the micro-controller first interprets the encrypted information of the first encrypted operator in the secure world to obtain a first decrypted result. Then, the micro-controller interprets the first decrypted result to generate second output data. During performing the interpretation operation, the micro-controller uses input data as the input data of the first decrypted result. Next, the micro-controller interprets the content information of the first operator in the non-secure world and provides the second output data of the first decrypted result as the input data of the first operator.

The present disclosure is not limit how step S513 is performed to interpret the first operator. In one embodiment, step S513 is performed to select one of algorithms stored in the non-secure world according to the tag information of the first operator. The input data (or second output data) and the first operator are substituted into the selected algorithm to generate first output data. Similarly, the present disclosure is not limit how step S515 is performed to interpret the first decrypted result. In one embodiment, step S515 is performed to select one of algorithms stored in the secure world according to the tag information of the first decrypted result. The first output data (or input data) and the first decrypted result substituted into the selected algorithm to generate second output data.

The number of un-encrypted operators in the non-secure world of the micro-controller and the number of encrypted operators in the non-secure world of the micro-controller are not limited in the present disclosure. The number of encrypted operators may be more than or fewer than the number of un-encrypted operators. In some embodiments, step 511 is performed to store a second operator and a second encrypted operator in the non-secure world of the micro-controller. In one embodiment, the first operator has higher priority than the first encrypted operator, the first encrypted operator has higher priority than the second operator, and the second operator has higher priority than the second encrypted operator. In a non-secure mode, the micro-controller selects a first algorithm among a plurality of algorithms stored in the non-secure world according to the tag information of the first operator. The first algorithm processes input data and the first operator to generate first output data.

Then, the micro-controller enters a secure mode. In the secure mode, the micro-controller first decrypts the encrypted information of the first encrypted operator to generate a first decrypted result. Then, the micro-controller interprets the first decrypted result. The micro-controller selects a second algorithm among the algorithms stored in the secure world according to the tag information of the first decrypted result. The second algorithm processes the first output data and the first decrypted result to generate second output data.

Next, the micro-controller enters the non-secure mode. In the non-secure mode, the micro-controller selects a third algorithm among the algorithms stored in the non-secure world according to the tag information of the second operator. The third algorithm is used to process the second output data and the second operator to generate third output data. In one embodiment, if the tag information of the second operator is the same as the tag information of the first operator, the third algorithm is the same as the first algorithm. In other words, if the tag information of the second operator is the same as the tag information of the first operator, the micro-controller selects the same algorithm to process the first and second operators.

Then, the micro-controller enters the secure mode. In the secure mode, the micro-controller first decrypts the encrypted information of the second encrypted operator to generate a second decrypted result. The micro-controller selects a fourth algorithm among the algorithms stored in the secure world according to the tag information of the second decrypted result. The fourth algorithm is utilized to process the third output data and the second decrypted result to generate fourth output data. Since the second encrypted operator is a final operator, the micro-controller serves the fourth output data as an inference output. In one embodiment, if the tag information of the second encrypted operator is the same as the tag information of the first encrypted operator, the fourth algorithm is the same as the second algorithm. In other words, if the tag information of the second encrypted operator is the same as the tag information of the first encrypted operator, the micro-controller selects the same algorithm to process the first and second encrypted operators.

Protection methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes a micro-controller and a secure system for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes a micro-controller and a secure system for practicing the disclosed methods. When implemented on a general-purpose processor, the program code combines with the processor to provide a unique apparatus that operates analogously to application-specific logic circuits.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. It will be understood that although the terms “first,” “second,” etc. may be used herein to describe various elements, these elements should not be limited by these terms. These terms are only used to distinguish one element from another. In the following claims, the terms “first,” “second,” etc. are used merely as labels, and are not intended to impose numerical requirements on their objects.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A micro-controller comprising:
a non-secure world comprising:
a first storage circuit storing a neural network model comprising an encrypted operator and a first un-encrypted operator;
a secure world comprising:
a key-store device storing a key;
a decryption circuit using the key to decrypt the encrypted operator to generate a decrypted result; and
a second storage circuit storing the decryption result; and
a processing circuit interpreting the first un-encrypted operator and the decrypted result,
wherein:
in a non-secure mode, the processing circuit interprets the first un-encrypted operator to generate first output data,
in a secure mode:
the processing circuit directs the decryption circuit to use the key to decrypt the encrypted operator,
the processing circuit interprets the decrypted result to generate second output data, and
the processing circuit stores the second output data in the first storage circuit.

2. The micro-controller as claimed in claim 1, wherein:
in response to the processing circuit interpreting the first un-encrypted operator, the processing circuit uses input data, and
in response to the processing circuit interpreting the encrypted operator, the processing circuit uses the input data.

3. The micro-controller as claimed in claim 1, wherein:
in response to the processing circuit interpreting the encrypted operator, the processing circuit uses input data, and
in response to the processing circuit interpreting the first un-encrypted operator, the processing circuit uses the second output data.

4. The micro-controller as claimed in claim 1, wherein:
the processing circuit executes a first software program to read first tag information of the first un-encrypted operator,
the processing circuit selects a first kernel according to the first tag information and uses the first kernel to process the first input data and the first un-encrypted operator to generate the first output data.

5. The micro-controller as claimed in claim 4, wherein:
the decrypted result comprises a first decrypted operator and a second decrypted operator,
the processing circuit executes a second software program to read second tag information of the first decrypted operator and third tag information of the second decrypted operator,
the processing circuit selects a second kernel according to the second tag information and uses the second kernel to process the first output data and the first decrypted operator to generate third output data,
the processing circuit selects a third kernel according to the third tag information and uses the third kernel to process the third output data and the second decrypted operator to generate the second output data.

6. The micro-controller as claimed in claim 4, wherein:
the decrypted result comprises a decrypted operator,
the processing circuit executes a second software program to read second tag information of the decrypted operator,
the processing circuit selects a second kernel according to the second tag information and uses the second kernel to process the first output data and the decrypted operator to generate the second output data.

7. The micro-controller as claimed in claim 6, wherein:
the neural network model further comprises a second un-encrypted operator,
in the non-secure mode, the processing circuit executes the first software program to interpret the second un-encrypted operator to generate fourth output information.

8. The micro-controller as claimed in claim 7, wherein the processing circuit selects a fourth kernel according to tag information of the second un-encrypted operator and uses the fourth kernel to process the second output data and the second un-encrypted operator to generate the fourth output data.

9. The micro-controller as claimed in claim 6, further comprising:
a first memory disposed in the non-secure world to store the first software program; and
a second memory disposed in the secure world to store the second software program.

10. The micro-controller as claimed in claim 9, wherein the processing circuit comprises:
a processor coupled to the first memory and the second memory,
wherein:
in the non-secure mode, the processor accesses the first memory to execute the first software program and accesses the second memory to execute the second software program.

11. A secure system comprising:
an offline tool comprising:
an encryption circuit receiving a neural network model comprising a first operator and a second operator, wherein the encryption circuit uses a first key to encrypt the second operator to generate a first encrypted operator; and
a micro-controller comprising:
a non-secure world comprising:
a first storage circuit storing the first operator and the first encrypted operator;
a secure world comprising:
a key-store device storing the first key;
a decryption circuit using the first key to decrypt the first encrypted operator to generate a decrypted result; and
a second storage circuit storing the decryption result; and
a processing circuit interpreting the first operator and the decrypted result,
wherein:
in a non-secure mode, the processing circuit interprets the first operator to generate first output data,
in a secure mode:
the processing circuit interprets the decrypted result to generate second output data and stores the second output data in the first storage circuit.

12. The secure system as claimed in claim 11, wherein the offline tool comprises:
a provision circuit provisioning the first key to the key-store device.

13. The secure system as claimed in claim 11, wherein the neural network model further comprises a third operator and a fourth operator, the encryption circuit uses a second key to encrypt the fourth operator to generate a second encrypted operator, and the first storage circuit stores the third operator and the second encrypted operator.

14. The secure system as claimed in claim 13, wherein the second key is different from the first key.

15. The secure system as claimed in claim 11, further comprising:
a first memory storing a first software program; and
a second memory storing a second software program,
wherein:
in the non-secure mode, the processing circuit executes the first software program to interpret the first operator, and
in the secure mode, the processing circuit executes the second software program to interpret the decrypted result.

16. A protection method for a micro-controller comprising a non-secure world and a secure world, comprising:
storing a first operator and a first encrypted operator in the non-secure world;
storing a key in the secure world;
in a non-secure mode:
interpreting the first operator to generate first output data;
in a secure mode:
using the key to decrypt the first encrypted operator to generate a first decrypted result;
interpreting the first decrypted result to generate second output data; and
storing the second output data in the non-secure world.

17. The protection method as claimed in claim 16, wherein the step of interpreting the first decrypted result to generate the second output data comprises:
reading first tag information of the first decrypted result;
selecting a first kernel of a plurality of kernels to process the first output data and the first decrypted result to generate the second output data.

18. The protection method as claimed in claim 17, further comprising:
storing a second operator and a second encrypted operator in the non-secure world;
in the non-secure mode:
interpreting the second operator to generate third output data;
in the secure mode:
using the key to decrypt the second encrypted operator to generate a second decrypted result;
interpreting the second decrypted result to generate fourth output data;
storing the fourth output data in the non-secure world.

19. The protection method as claimed in claim 18, wherein the step of interpreting the second decrypted result to generate the fourth output data comprising:
reading second tag information of the second operator;
selecting a second kernel of the plurality of kernels according to the second tag information;
processing the second output data and the second operator according to the second kernel to generate the third output data.

20. The protection method as claimed in claim 19, wherein in response to the second tag information being the same as the first tag information, the second kernel is the same as the first kernel.
